(19) United States
(12) Patent Application Publication
(10) Pub. No.: US 2025/0049263 A1
(43) Pub. Date: Feb. 13, 2025

(54) ROBOTIC FRYING SYSTEM

(71) Applicant: Lab2Fab, LLC, Fremont, CA (US)

(72) Inventors: Samuel Lewis Tanaka, San Leandro, CA (US); Shawn Michael Lange, Walnut Creek, CA (US)

(21) Appl. No.: 18/799,788

(22) Filed: Aug. 9, 2024

Related U.S. Application Data
(60) Provisional application No. 63/531,779, filed on Aug. 9, 2023.

(51) Int. Cl. A47J 37/12; B25J 5/02; B25J 11/00

(52) U.S. Cl. CPC A47J 37/1228; A47J 37/1219; A47J 37/1266; A47J 37/1276; B25J 5/02; B25J 11/0045

(57) ABSTRACT

Example robotic food preparation systems for integration with a cooking device may comprise one or more attachment panels having attachment location(s) for rigidly physically attaching to the cooking device. A rail may be attached to the one or more attachment panels, and may be positioned to extend laterally across a front-facing surface of the cooking device when the one or more attachment panels are physically attached to the cooking device. The system also includes a carriage positioned on the rail to slidably engage along the lateral extension of the rail and includes a locator to fix a first position of the carriage along the lateral extension of the rail. The system may also include a robotic arm supported by the carriage, wherein, when the carriage is fixed at the first position, the robotic arm is positioned relative to the cooking device to interact with the cooking device to cook food items.

### CROSS-REFERENCE TO RELATED APPLICATIONS

This application claims the benefit of U.S. Provisional Patent Application No. 63/531,779 filed Aug. 9, 2023, the disclosure of which is hereby incorporated by reference herein in its entirety for all purposes.

### INTRODUCTION

The present disclosure is directed to apparatuses, systems, and methods for cooking consumable items, and more particularly, to a robotic food preparation system for integration with a cooking device.

### BACKGROUND

Robotic automated food preparation systems have been developed for automating various kitchen operations of a restaurant. For example, each of U.S. patent application Ser. No. 17/494,664 (filed on Oct. 5, 2021) and U.S. Provisional Patent Application Ser. No. 63/088,162 (filed on Oct. 6, 2020) disclose examples of robotic automated food preparation systems that may be used to fry consumable items such as French fries, onion rings, chicken, and other related consumable items. Additionally, each of U.S. Provisional Application Ser. No. 63/299,334 (filed on Jan. 13, 2022), U.S. Provisional Application Ser. No. 63/300,445 (filed on Jan. 18, 2022), U.S. Provisional Application Ser. No. 63/349,873 (filed on Jun. 7, 2022), U.S. Provisional Application Ser. No. 63/356,784 (filed on Jun. 29, 2022), U.S. Provisional Application Ser. No. 63/394,154 (filed Aug. 1, 2022), U.S. Provisional Application Ser. No. 63/395,677 (filed Aug. 8, 2022), U.S. Provisional Application Ser. No. 63/419,631 (filed on Oct. 26, 2022), U.S. patent application Ser. No. 18/096,388 (filed Jan. 12, 2023), and U.S. patent application Ser. No. 18/098,437 (filed Jan. 18, 2023) disclose examples of robotic food preparation systems that may be used to guide, move, or distribute various consumable items (e.g., those mentioned above) or otherwise facilitate a cooking process to enable consistent, sterile, and/or automated handling of the consumable items as the consumable items are prepared for consumption (e.g., enabling the safe and consistent handling of recently fried consumable items). Moreover, U.S. Provisional Application Ser. No. 63/349,873 (filed on Jun. 7, 2022) discloses examples of alignment apparatuses for a basket, while U.S. Provisional Application Ser. No. 63/459,299 (filed on Apr. 14, 2023) and U.S. patent application Ser. No. 18/627,569 (filed Apr. 5, 2024) each disclose examples of basket reload systems for providing food items to a robotic frying system. The contents of each of the above-referenced applications are hereby expressly incorporated by reference in their entireties.

In some automated cooking systems, e.g., in the aforementioned applications, a robotic arm is employed to move consumable items within the system. Merely as examples, a multi-axis robot arm may be used to move a basket from a bulk dispenser to a fryer to facilitate cooking of consumable items carried in the basket in the fryer. Similarly, the robot arm may move the basket containing the cooked consumable items from the fryer to a finishing or holding station. Known robotic arms and associated support systems may consume a significant footprint around or in front of a cooking device such as a fryer. For example, robot arms are typically supported from a floor surface adjacent the cooking device. Generally, the robotic arm must be removed from the cooking device to facilitate access, e.g., for maintenance of a fryer. Accordingly, there is a need for an automated cooking system that automates food preparation with robotic equipment such as a multi-axis arm, while facilitating access to the cooking device during periods of non-use of the robotic equipment.

### SUMMARY

In at least some examples, a robotic food preparation system for integration with a cooking device comprises one or more attachment panels comprising a plurality of attachment locations for rigidly physically attaching to the cooking device. The system also includes a rail attached to the one or more attachment panels. The rail may be positioned to extend laterally across a front-facing surface of the cooking device when the one or more attachment panels are physically attached to the cooking device. The system also includes a carriage positioned on the rail to slidably engage along the lateral extension of the rail and includes a locator to fix a first position of the carriage along the lateral extension of the rail. The system may also include a robotic arm supported by the carriage, wherein, when the carriage is fixed at the first position, the robotic arm is positioned relative to the cooking device to interact with the cooking device to cook food items.

In at least some examples, a support assembly configured to secure a robotic arm to a cooking device in a food preparation system comprises first and second attachment panels, each having a respective plurality of attachment locations for rigidly physically attaching each attachment panel to a respective side of the cooking device. The support assembly may also include a rail having a first end and a second end. The first end may be attached to the first attachment panel, and the second end may be attached to the second attachment panel such that the rail extends laterally across a front-facing surface of the one or more cooking devices when the one or more attachment panels are physically attached to the cooking device. The support assembly may further include a carriage positioned on the rail to slidably engage along a lateral extension of the rail and including a locator to fix a first position of the carriage along the lateral extension of the rail.

In at least some examples, a method of securing a robotic arm to a cooking device in a robotic food preparation system includes rigidly physically attaching a first attachment panel to the cooking device at a plurality of attachment locations. The method also includes rigidly physically attaching a second attachment panel to the cooking device at a second plurality of attachment locations. The method further includes attaching a first end of a rail to the first attachment panel, and attaching a second end of the rail to the second attachment panel. The rail extends laterally across a front-facing surface of the cooking device. The method also includes positioning a carriage on the rail, the carriage configured to slide along the lateral extension of the rail, the carriage including a locator to fix a first position of the carriage along a lateral extension of the rail. Additionally, the method includes supporting the robotic arm with the carriage, wherein, when the carriage is fixed at the first position, the robotic arm is positioned relative to the cooking device to interact with the cooking device to cook food items.

### BRIEF DESCRIPTIONS OF THE DRAWINGS

The above and other objects and advantages of the disclosure may be apparent upon consideration of the following detailed description, taken in conjunction with the accompanying drawings, in which:

FIG. 1A depicts a perspective view of a robotic food preparation system having a plurality of fryers with a robotic arm secured to the fryers with a rail, in accordance with some embodiments of the disclosure;

FIG. 1B depicts a front view of the robotic food preparation system of FIG. 1A, in accordance with some embodiments of the disclosure;

FIG. 1C depicts a left-side view of the robotic food preparation system of FIGS. 1A and 1B, in accordance with some embodiments of the disclosure;

FIG. 1D depicts a top view of the robotic food preparation system of FIGS. 1A-1C, in accordance with some embodiments of the disclosure;

FIG. 2 depicts a perspective view of the robotic food preparation system of FIG. 1, illustrated with the robotic arm positioned in a first location to allow a first of a plurality of cabinet doors to be opened, in accordance with some embodiments of the disclosure;

FIG. 3 depicts a perspective view of the robotic food preparation system of FIG. 2, illustrated with the robotic arm positioned in a second location to allow a second one of the cabinet doors to be opened, in accordance with some embodiments of the disclosure;

FIG. 4 is a side view of an attachment panel for a rail in the robotic food preparation system of FIGS. 1-3, in accordance with some embodiments of the disclosure;

FIG. 5 is an enlarged left-side perspective view of the attachment panel and rail of FIG. 4, in accordance with some embodiments of the disclosure;

FIG. 6 is a flow chart representing an illustrative method of securing a robotic arm to a cooking device in a robotic food preparation system, in accordance with some embodiments of the disclosure.

### DETAILED DESCRIPTION

Example illustrations herein are generally directed to systems and methods that provide automated food preparation (e.g., as executed by at least one robotic apparatus) including handling of fryer baskets using a robotic arm. Example automated systems described herein facilitate the safe, clean, cost-effective, and timely performance of bulk or specialized food preparation operations by utilizing robotic equipment and other automated features to perform food preparation operations that may otherwise create substantial issues of operator safety, ergonomics, and cleanliness. Although the present disclosure is described in the context of an automated frying system facilitated with one or more robot arms, the robotic food preparation system described in the present disclosure may be utilized with other automated components to perform other food preparation operations.

A robotic component such as a multi-axis robotic arm may be located relative to a cooking device to perform a number of operations to facilitate automated cooking. In an example of a robotic frying system, a number of fryers each include frying locations for locating fry baskets (e.g., two for each fryer). A robotic arm can receive food items (e.g. frozen food items such as fries, onion rings, chicken tenders, chicken wings, etc.) from a dispenser (e.g., one or more dispensers capable of dispensing different items) such as by accessing a dispensing location or receiving the food items from the dispenser via a basket reload system such as that described in U.S. patent application Ser. No. 18/627,569 (filed Apr. 5, 2024). For example, the robotic arm may grip fry baskets that receive the food items and then provide the fry basket to suitable locations of the fryers for receiving a fry basket. Once received, automated equipment of the fryers may lower the fry basket vertically into the fry oil, and the frying may be controlled as to time, temperature, etc. While the food items are being fried, the robotic arm may perform other operations such as receiving additional food items and providing fry baskets to additional fryer receiving areas, moving fried items from the fryer to a staging location (e.g., a crisper area), shaking the fry basket to unclump fried items or remove fry oil, facilitating other operations such as seasoning, skimming particulates from fry oil, filtering, and the like.

Although a robotic component such as a robotic arm may provide for timely, efficient, and safe frying of food items, as noted above the robotic arm and its physical mounting may consume a large footprint both with respect to a range of motion and normal to the front surfaces of the fryers (e.g., extending into an aisleway). The robotic arm and associated physical components such as mounting areas, utility supplies, etc. may interfere with locations where other operations (manual or automated) may need to be performed, such as doors and panels for accessing utilities, waste materials, and performing routine maintenance. Further, in view of the multitude of food items that can be prepared with an automatic frying system and the substantial floor space of the fryers alone, allowing multiple food items to be automatically prepared provides for efficient use of space and resources.

Accordingly, example approaches generally provide an attachment and support system for a robotic frying system that allows for attaching a robotic arm relative to partially automated fryers. As an example, if two or three fryers are situated next to and attached to each other, an attachment and support system physically couples to one or more of the fryers such that the robot is fixedly and repeatedly located relative to the fryers. For example, attachment panels of the attachment and support system may be fixedly coupled (e.g., via bolts, slots, mutually engaged plates, welding, magnets, magnetic coupling, or other suitable methods to exterior facing outer sides of each of a right-side and left-side fryer. A rail may be fixedly attached to the attachment panels, such that the rail extends along a length of the front side of all of the fryers. A carriage may be seated on the rail and may support a robotic arm, allowing the robotic arm to be moved along a laterally extending front face of the fryers. Utility connections to the robotic arm may run along the rail but have sufficient slack such that the robotic arm can move back and forth with the carriage along the rail when the carriage is not fixed to the rail (e.g., via a releasable pin, solenoid actuator, or magnetic coupling/locking). In some examples, the carriage may move along the rail without tensioning the utility connections between a location of a coupling to the robot arm and a side of the rail from which the utility connections extend. A sensor or switch may be associated with the attachment methodology of the carriage, such that a signal confirms that the carriage is fixed before imparting motion by the robotic arm. A scanning sensor may be located on a bottom side of the carriage to identify the presence of people, machines, or other items within proximity to the fryer or robotic arm, which may in turn may be used to control movement of the robotic arm or other automated operations (e.g., operation of an automated fryer, or dispensing of food items).

The entirety, or virtually all, of the operations of the automated frying system may be centrally controlled by a computing system that interacts with the robotic arm, sensors, fryers, crisper, dispenser, basket reload, and other components via wired or wireless communications and use of program calls, APIs, and the like. In some instances a basket reload system may include multiple dispensers located adjacent to each other. Each station may include multiple items to be dispensed, which in turn are dispensed downward towards a feeding system such as a conveyor. In some instances, multiple conveyors can be located adjacent to each other such that food items are transferred from conveyor to conveyor, such as via a shuttling system, relative locations (e.g., height) of conveyors, speed of conveyors, and the like, and eventually to a basket reload system. In this manner, and through integrated interaction of multiple components, an entirety of the preparation of fried food items may be performed from ordering between numerous options stored into dispensers, unique cooking profiles, and delivery to a temporary storage location or to packaging for delivery to a customer.

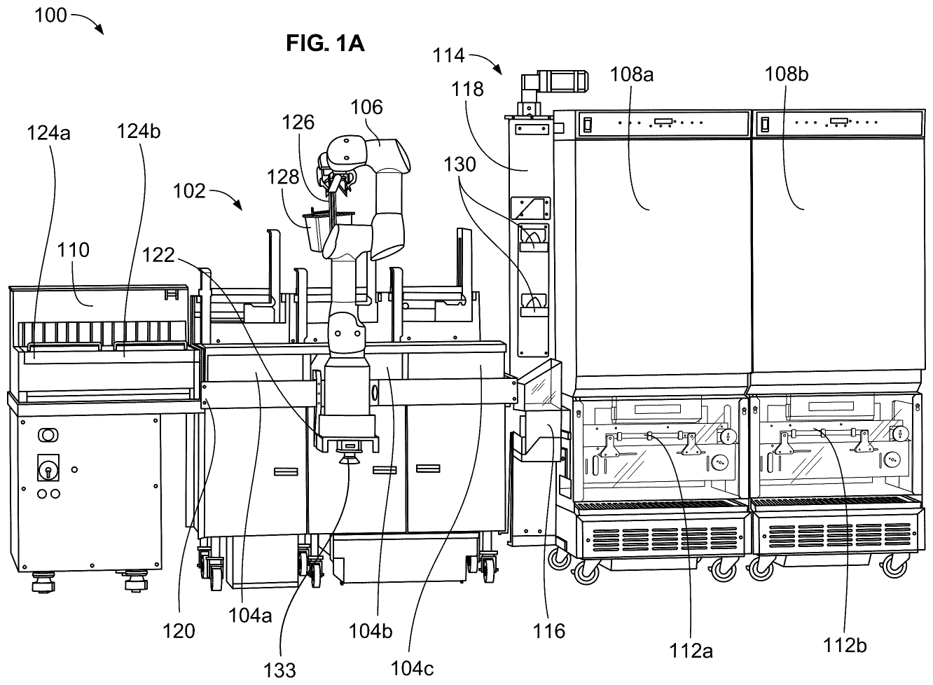

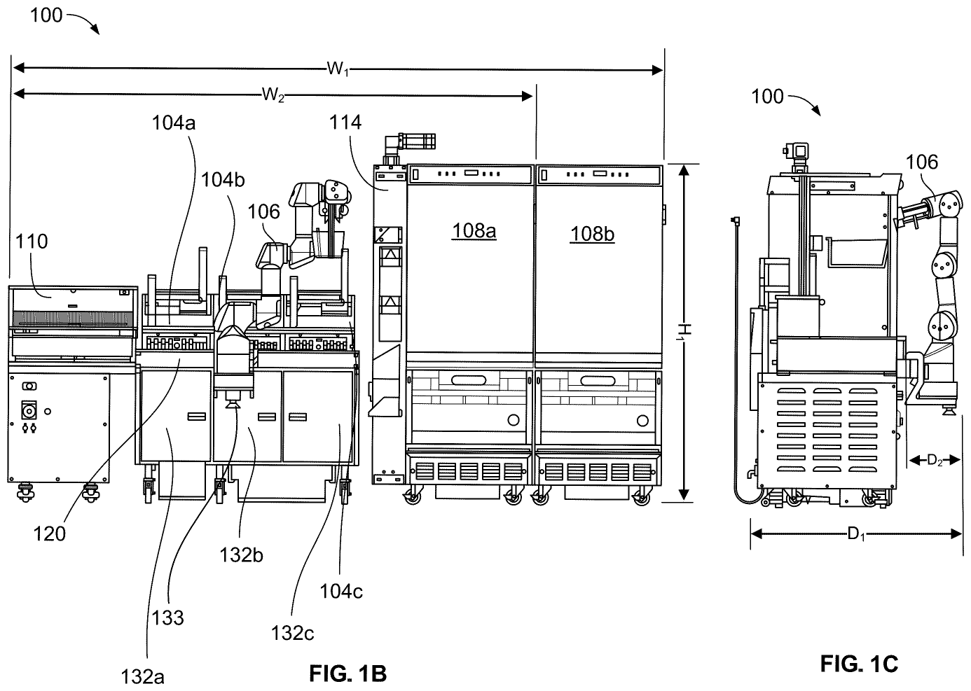

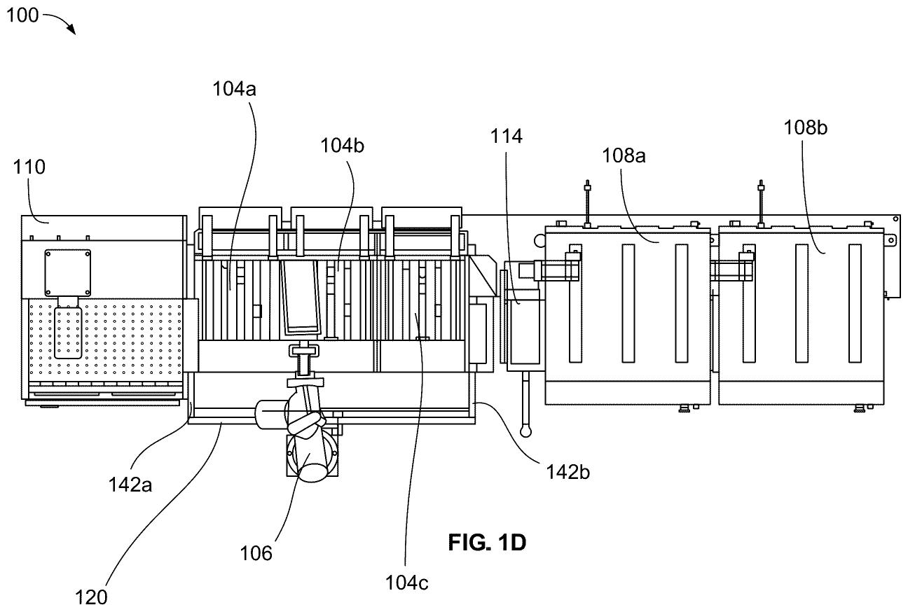

Referring now to FIGS. 1A-ID, an example robotic food preparation system 100 is illustrated and described in further detail. Generally, robotic food preparation system 100 is configured to integrate a cooking device 102 to facilitate automated cooking, e.g., frying. In the illustrated example, the cooking device comprises a plurality of fryers 104a, 104b, 104c (collectively, 104). While the illustrated example includes three fryers 104, as will be discussed further below other examples may have a single fryer, or any other number of multiple fryers that is convenient. The illustrative system 100 enhances efficiency and safety of food preparation by incorporating a robotic arm 106 that can interact with the cooking device 102, thus minimizing the need for human intervention in potentially hazardous environments. The system 100 comprises various components and mechanisms that ensure precise and flexible operation, allowing it to adapt to different cooking devices 102 and configurations.

As shown in FIGS. 1A-1D, the robotic arm 106 is supported on the cooking device 102 and is adjacent one or more bulk dispensers 108a, 108b to the right of the cooking device 102. The bulk dispensers 108 may generally maintain raw or frozen consumable items, and may dispense the consumable items for cooking in the cooking device 102. Merely by way of example, as illustrated the dispensers 108a, 108b may each have a respective conveyor 112a, 112b configured to transport quantities of bulk consumable items, e.g., a quantity of French fries, chicken nuggets, tenders, etc., and dispense them laterally.

In the illustrated example of FIGS. 1A-1D, the bulk dispenser 108a may dispense consumable items via a gravity feed from an internal storage area to the conveyor 112a, and may dispense the quantity of consumable items to a basket reload system 114. Additionally, the bulk dispenser 108b may dispense a quantity of consumable items via a similar gravity feed from an internal storage area to its conveyor 112b, with the conveyor 112b laterally transporting the dispensed quantity to the conveyor 112a of the bulk dispenser 108a. The bulk dispenser 108a may then dispense the quantity received from the bulk dispenser 108b to the basket reload system 114 via the conveyor 112a. Accordingly, bulk dispensers 108a, 108b may store and dispense quantities of consumable items for cooking in the cooking device 102. The bulk dispensers 108a and 108b may each store same or different types or quantities of bulk consumable items, e.g., bulk dispenser 108a may store French fries, while bulk dispenser 108b stores chicken tenders, or both bulk dispensers 108a, 108b may each store French fries, etc.

The basket reload system 114 may cooperate with the robotic arm 106 to transport bulk consumable items from the dispenser(s) 108 to the cooking device 102 for cooking. For example, the basket reload system 114 may include a dump bin 116 configured to move vertically along a vertical track 118, e.g., as described in the above-noted U.S. patent application Ser. No. 18/627,569 (filed Apr. 5, 2024), and entitled BASKET RELOAD SYSTEM, which is incorporated by reference herein in its entirety. In this example, one or both of the conveyors 112a, 112b of the bulk dispensers 108a, 108b may serve as a transfer component to feed quantities of dispensed items horizontally to the dump bin 116. The dump bin 116 may move the dispensed food items vertically along the vertical track 118 to location(s) suitable for providing the food item to a fry basket 128 held by the robotic arm 106 by way of an elongate handle 126 extending from the basket 128.

Baskets 128 may also be positioned temporarily at desired locations along the vertical track 118, e.g., at basket retainers 130. The basket retainers 130 may facilitate a collaborative mode of the system 100, in which an employee may place a pre-loaded basket on a basket retainer 130 for temporary storage, with the basket 128 eventually being picked by the robotic arm 106 at a suitable time for the system 100 to cook the contents of the manually-placed basket 128. Merely by way of example, an employee working with the collaborative robotic arm 106 in this manner may load niche items that are not stored in the dispenser(s) 108.

A staging location 110 is positioned to the left of the robotic arm 106 and cooking device 102. In the example illustrated, the staging location 110 is a crisper configured to maintain cooked consumable items received from the cooking device 102 at a desired temperature, e.g., by keeping warm with lamps, heaters, or the like. The staging location 110 may facilitate seasoning of cooked consumable items, e.g., by application of salt, pepper, or other granulated seasoning. To this end, seasoning of consumable items at the staging location may be automated by way of a seasoning dispenser, as described in U.S. patent application Ser. No. 18/215,226, filed Jun. 8, 2023, and entitled AUTOMATED SEASONING DISPENSER, which is incorporated by reference herein in its entirety. When utilized in a collaborative mode or robotic system as described herein, the seasoning dispenser may be actuated by an employee retrieving cooked food items from the staging area 110 without limiting the operation of the robotic arm 106 performing other operations (e.g., retrieving frozen/uncooked consumable items from a dispenser 108, or dump bin 116 of basket reload system 114). In other examples, the dispensing may be performed automatically after the cooked/fried items are provided to the staging location 110.

While the example cooking device 102 includes three side-by-side fryers 104, this is not limiting and other examples may employ a different number of fryers 104, or a single fryer 104. Additionally, while the example system 100 is illustrated with two side-by-side bulk dispensers 108, in other examples a single bulk dispenser may be sufficient. Moreover, in other example approaches it may be desired for the system 100 to have more than two bulk dispensers 108.

As will be discussed further below, the robotic arm 106 may be attached to the cooking device 102 and/or the fryers 104 in a middle portion of the system 100. More specifically, a support system may include a rail 120 and a carriage 122 supporting the robotic arm 106. In this manner, a footprint of the robotic arm 106 within the system 100 may be relatively reduced, e.g., by preventing the robotic arm 106 from consuming floor space in front of the cooking device 102. Furthermore, the rail 120 may facilitate moving of the robotic arm 106, which may be convenient during periods of non-use of the robotic arm 106 to facilitate access to the cooking device 102 or other components of the system 100.

The supporting of the robotic arm 106 from the rail 120 may result in a compact overall system 100. For example, the system 100 may have dimensions depicted in FIGS. 1B, 1C, and 1D, as an example illustration of the overall floor space and clearance required for the robotic frying system 100. In the illustrated example, the system 100 has a width W₁ of 144″ with the two dispensers 108, and a height H₁ of 81.7″ for the dispenser(s) 108, and less than the height H₁ being required for the robotic arm 106 over the cooking device 102/fryers 104. In another example, a width dimension W₂ is relatively reduced to 115.6″ for a system having a single dispenser 108. The total depth D₁ of the integrated system may be 46.4″, with the robotic arm support assembly including the rail 120, carriage 122, and robotic arm 106 consuming a depth D₂ of less than a foot (e.g., 11.5″), and providing clearance under the robotic arm 106, e.g., to facilitate access to utility and supply doors, disposal trays, and the like of fryers attached to the robotic arm. In this manner, the system 100 is compact and capable of supporting all of a restaurant's frying needs without imposing significant additional space constraints for supporting frying operations.

All of the components of the robotic frying system 100 may be communicatively coupled, e.g., the dispenser(s) 108, basket reload system 114, cooking device 102, staging location 110, etc. such that the operations of each component of the system 100 are controlled and integrated to facilitate timely and safe operations of the system 100. Control and processing can be controlled by a single program/system communicating with each component, while in other examples operations may be distributed. The system may also communicate with other restaurant systems such as automated delivery devices, employee electronic devices, point of sale systems, and the like, to automatically receive and process orders and provide notifications to employees or automated delivery devices to access cooked food items and provide them to customers. Examples of such systems are depicted and described at U.S. patent application Ser. No. 16/780,797, filed Feb. 3, 2020, and entitled INTEGRATED FRONT-OF-HOUSE AND BACK-OF-HOUSE RESTAURANT AUTOMATION SYSTEM, which is incorporated by reference herein in its entirety.

Accordingly, when an order is received an appropriate portion of the food item may be provided from one of the dispensers 108. As noted above, multiple dispensers 108 may be included in the system, although additional dispensers may be included in accordance with the present disclosure. Further, each dispenser 108 may have multiple internal storage areas or compartments (e.g., 2, 3 or 4 compartments) holding different food items to be dispensed. In this manner, the dispensers 108 of the robotic frying system 100 may collectively be able to dispense multiple food items depending upon the particular configuration. The selected food item (or, if to be combined, multiple food items) may be fed from the appropriate compartment of each dispenser 108 (e.g., gravity and/or supported feeding) and portioned (e.g., by monitoring the dispensing with sensors and/or measuring a weight of the dispensed portion) and provided to the basket reload system 114.

Where multiple dispensers 108 are located adjacent to each other, e.g., as illustrated in FIGS. 1A-1D, a transmission path for food items from the far-right dispenser 108b to be transferred to the vertical track 118 and dump bin 116 of the basket reload system 114 may be provided, e.g., via the transfer component 112a of the left-side dispenser 108a located adjacent to the vertical track 118 and dump bin 116. Although a variety of transfer components 112 may be used in different embodiments, in an example embodiment each of the transfer components 112 may be a conveyor (e.g., a conveyor belt, a conveyor with portioned compartments, etc.) and food items from the right-side dispenser 108b may be transferred from its conveyor 112b to a conveyor 112a of the left-side dispenser 108a, and via that conveyor 112a, to the dump bin(s) 116 and vertical track 118. In some implementations, to assist in the transfer between conveyors, the right-side conveyor 112b may have a greater height (e.g., by 1 to 4 inches) and appropriate feed speed to provide the food items to the left-side conveyor 112a without requiring additional components such as a transfer station between the conveyors. In another example, cleated belts or a ramp incline on the conveyor may propel or “launch” material up onto another conveyor. In other embodiments, a transfer station may be located between the transfer components of the respective dispensers 108, for example, a lateral-moving or rotating shuttle attached to either of dispensers 108. In another example, an electro-mechanical or pneumatic pusher, or a rotary sweeping arm may be provided to facilitate movement or transfer of objects from one conveyor to another conveyor.

The vertical track 118 transfers the dump bins 116 vertically toward an access location for the robotic arm 106, which may be a location where the robotic arm 106 locates a fry basket 128 held by the robotic arm 106. The food items to be processed are provided to the fry basket 128 by the dump bin 116 (e.g., by a door of the dump bin 116 opening to release contents via gravity feed, or by the dump bin 116 rotating to provide a gravity feed to the fry basket 128) and the robotic arm 106 then locates the fry basket 128 at an appropriate fry location of the fryers 104. Although three fryers each having two frying locations are depicted in FIGS. 1A-1D, as noted above additional or fewer fryers may be utilized, as well as different numbers and sizes of frying locations (e.g., larger locations accommodating larger fry baskets or high-throughput items, and smaller locations for niche items).

The robotic arm 106, in accordance with instructions provided by the robotic frying system, places the fry basket 128 with food items at an appropriate frying location within an appropriate fryer 104. The fryer 104 may be automated to automatically lower the fry basket 128 and cook the food items in a manner appropriate for the particular food item and order, modifying heat profiles, cook time, etc., as appropriate. When the food item is cooked, the fryer 104 lifts the fry basket 128 from the fry oil and the basket 128 is available for the robotic arm 106 to move the cooked items to one or more staging locations 110.

The staging locations 110 may include multiple compartments 124a, 124b for different food item types and/or multiple staging locations 110 may be provided. In this manner, a single robotic arm 106, coordinated with a basket reload system 114, may provide for seamless and efficient frying, moving items quickly from dispensing, to a fryer 104, and to the staging location 110 with minimal dwell or cooling time, providing for consistent food preparation. The robotic arm 106 may also perform other ancillary operations, such as agitating items before or after cooking to prevent clumping or to remove excess fry oil, or facilitate seasoning by providing a fry basket to a seasoning location.

The robotic arm 106, as noted above, is located at a central location with respect to the fryers 104, basket reload system 114, and staging area 110, and can be easily accessed with minimal non-productive movement steps. For example, both lateral and vertical movement are minimized to improve operational efficiency. In the embodiment depicted in FIGS. 1A-1D, the robotic arm 106 operates from a fixed location on the rail 120 via the support carriage 122, such that the carriage 122 and robotic arm 106 do not move laterally during cooking operations. In embodiments where an additional range of movement is needed (e.g., with additional fryers 104, dispensers 108, or staging locations 110, the carriage 122 may be automated to move between two or more lateral locations along the rail 120, or to a variety of lateral locations within an overall range of motion.

In some implementations, the robotic arm 106 may be a “collaborative robot” that operates with speeds and forces that allow employees to work alongside the robotic arm 106, for example, to change dispensers 108, access food items from staging area 110, service trays and consumables, apply seasoning, and the like. In the event that the robotic arm 106 contacts an employee, the robotic arm 106 may temporarily stop moving, slow movement to one or more relatively reduced speeds, or may perform other operations. In some instances, a sensor 133 such as a 2D planar lidar scanner may be utilized to facilitate collaborative interfacing with employees, for example, located at the bottom of the robotic arm 106 and carriage 122 as depicted in FIGS. 1A, 1B, and 1C. By knowing the location, movement direction, movement speed, and similar information about employees in the area, the movements of the robotic arm 106 may be coordinated with those of employees, for example, by modifying sequences of operation or movements of the robotic arm between locations. In some examples, based on a presence and/or identification of items around the carriage 122 and/or the robotic arm 106, system 100 can adjust operations of the robotic arm 106, such as by altering (e.g., reducing) a range of motion of the robotic arm 106, changing an order of operations, or adjusting (e.g., reducing) a speed of movement of the robotic arm 106 to ensure safe and efficient functioning.

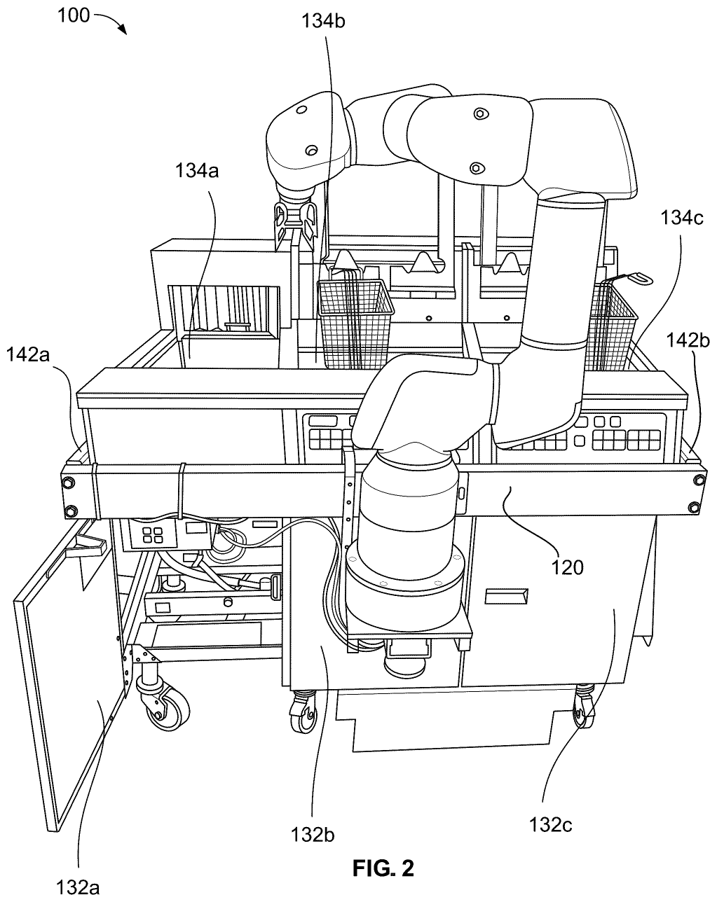

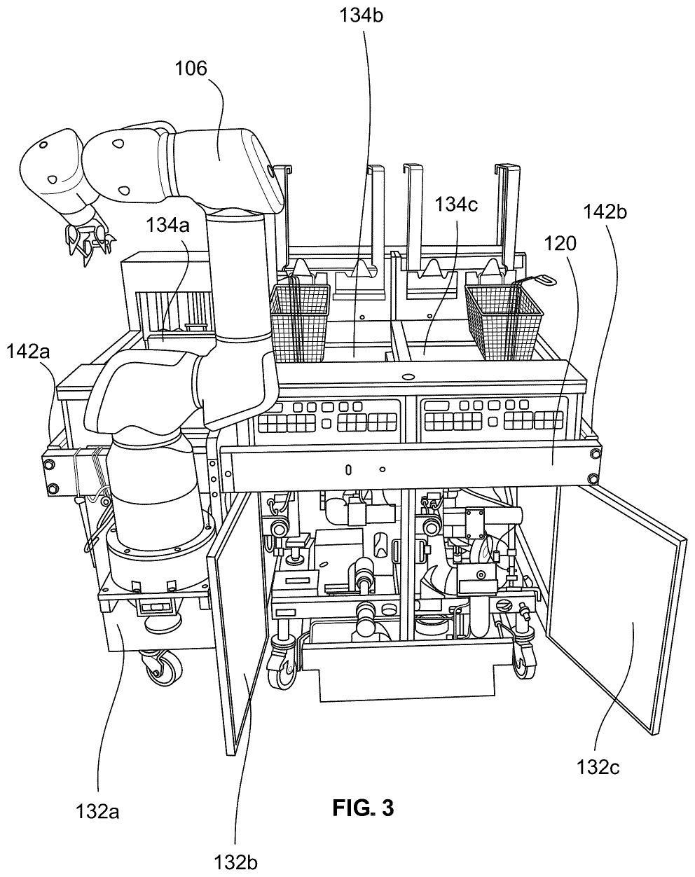

Referring now to FIGS. 2 and 3, the robotic food preparation system 100 is illustrated with the robotic arm 106 positioned in different locations along the rail 120. In some examples, movement of the carriage 122 and/or robot 106 along the rail 120 may facilitate access to different areas of the cooking device 102, e.g., different fryers 104 for maintenance or cleaning. In the example illustrated, the cooking device 102 includes a plurality of doors 132a, 132b, 132c corresponding to positions below the fryers 104a, 104b, 104c. Accordingly, the robot arm 106 may be moved along the rail 120 to facilitate opening of different doors 132 and access to corresponding areas of the fryers 104. For example, in FIG. 2 the carriage 122 is positioned at a first location on the rail 120 to allow door 132a to be opened. By contrast, in FIG. 3 the carriage 122 is positioned at a second location along the rail 120 closer to an end of the rail 120, thereby allowing door 132b and/or door 132c to be opened.

The carriage 122 and robotic arm may be 106 fixed at a location on the rail 120 during cooking, e.g., in the position illustrated in FIG. 2, using an attachment pin or the like, which will be described further below. The rail 120 is located at a height such that access doors 132a, 132b, 132c and trays or oil reservoirs 134a, 134b, 134c of the fryers 104a, 104b, 104c may be accessed without interference of the rail 120. Additionally, to facilitate maintenance, cleaning, and the like, the carriage 122 and robotic arm 106 may be moved laterally along the rail 120 to allow access to any of the doors 132. Power, communications, and sensor inputs/outputs for the robotic arm 106 may be coupled together into a single utility line 138 that extends along the rail 120 on one side, which may have sufficient slack to allow the movement of the robotic arm 106 and carriage 122 along the rail 120. For example, the utility line 138 may be coupled to the rail via toggle bungies, silicone coated straps, plastic wire wrap, a snap-on or Velcro cable sleeve, or any other food-safe device that facilitates coupling/uncoupling of the utility line. The length of the utility line 138 may be such that movement of the carriage 122 along the rail 120 does not tension the utility line. For example, the length of the utility line 138 may be greater than a linear distance from a distal connection point of the utility line 138 away from the carriage, to a furthest position of the carriage. Guards or stops may be included on the rail to contain movement of the carriage 122 and robotic arm 106 along the rail 120, e.g., to prevent the carriage 122 from moving beyond certain lateral locations along the rail 120.

The system 100 may be configured to confirm a position of the carriage 122 and/or robotic arm 106, e.g., to ensure the robotic arm 106 is in a desired position for operation, to prevent interference with opening of door(s) 132, etc. In some examples, sensors may be integrated into the cooking device 102, rail 120, carriage 122, and/or robotic arm 106 to confirm the carriage 122 is at a first position, e.g., as illustrated in FIG. 2. Additionally, in some example approaches the robotic arm 106 may be programmed to remain inoperative unless this sensor verifies the carriage's position on the rail 120, thereby ensuring safe operation. Additionally, as shown in FIGS. 2 and 3, a scanner 140 may be positioned on or adjacent to a bottom side of the carriage 122 that is configured to detect a presence of items around the carriage 122. Based on this detection, the system 100 can modify one or more operations of the robotic arm 106 to avoid collisions and optimize movement. For example, a movement speed of the robotic arm 106 may be reduced, or motion of the robotic arm 106 may be prevented entirely.

The rail 120 may be secured to the cooking device 102 in any manner that is convenient. For example, referring now to FIGS. 2, 3, 4 and 5, the rail 120 may be supported at opposite ends thereof by way of attachment panels 142a, 142b. The attachment panels 142 may be positioned on opposite sides of the cooking device 102, such that the rail 120 extends across a front-facing surface of the cooking device 102. Attachment panels 142 may be positioned on opposite sides of a cooking device 102 comprising any number of fryers 104 that is convenient. Accordingly, while the illustrated examples include three separate fryers 104a, 104b, and 104c, in other example approaches a different number of fryers 104 may be employed. In the illustrated configuration with three fryers 104a, 104b, 104c, the attachment panel 142a is secured to the left side of the fryer 104a and the attachment panel 142b is secured to the right side of the fryer 104c, with the fryer 104b positioned between the fryers 104a and 104c. The first position of the carriage is located on the left side of the first fryer, and the second position is on the right side of the second fryer. The attachment panel 142a may be formed of a rigid material, e.g., steel, aluminum, or the like, facilitating a relatively rigid and secure attachment of the rail 120 to the cooking device 102.

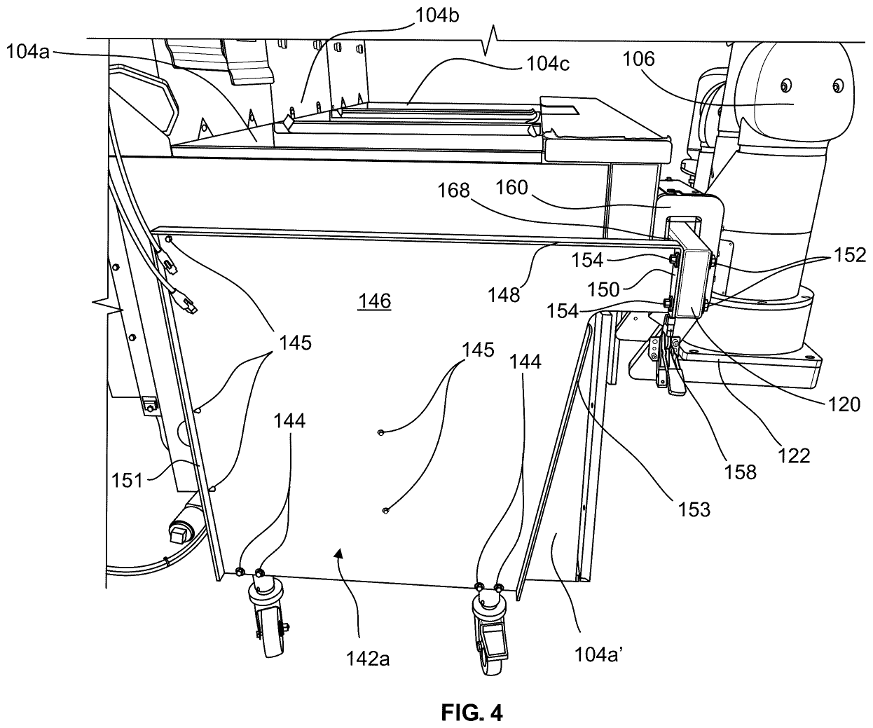

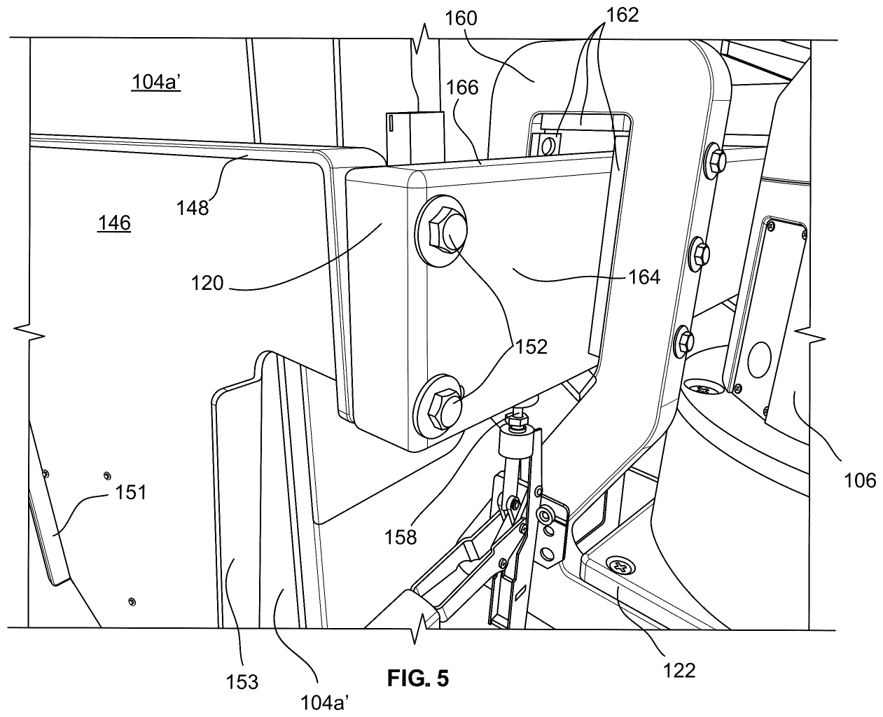

As best seen in FIGS. 4 and 5, attachment panel 142a may include multiple attachment locations configured to facilitate securement of the attachment panel 142a to a side panel 104a′ of the fryer 104a. Additionally, the securement of the attachment panel 142a at multiple locations to the side panel 104a of the fryer 104a may further enhance the rigidity of the attachment panel 142a. The attachment panels 142 generally may rigidly and securely attach the system to the cooking device, ensuring stability during operation. In the illustrated example, attachment locations are provided by a plurality of main apertures 144 and a plurality of secondary apertures 145 in a planar body 146 of the attachment panel 142a. The main apertures 144 receive corresponding threaded fasteners (e.g., bolts) which may extend into corresponding threaded nuts on an inner side of the side panel 104a′ of the fryer 104a (or otherwise into corresponding threaded apertures in structure of the fryer 104a), thereby clamping the planar body 146 to the side panel 104a of the fryer 104a. In the illustrated example, the four threaded fasteners extending through the four main apertures 144 carry most of the load for the robotic arm 106 and rail 120, with the load being carried in shear by the fasteners in the main apertures 144. Additional attachment locations may be provided by secondary apertures 145 of the attachment panel 142a, which may be a smaller dimension (e.g., smaller in diameter) than the main apertures 144. The secondary apertures 145 may receive corresponding fasteners, e.g., screws, which are received in corresponding tap holes or threaded openings of the side panel 104a (or other exterior part of the fryer 104). In the illustrated example, fasteners extending through the secondary apertures 145 of the attachment panel 142a may generally draw the attachment panel 142a against an outer panel 104a′ of the fryer 104a. Otherwise, the outer panel 104a may tend to bow in or out relative to the side panel 104a. Accordingly, the additional fasteners (e.g., screws) extending through the secondary apertures may reduce or prevent gapping between the attachment panel 142a and the side panel 104a′ of the fryer 104a.

To increase overall rigidity of the planar body 146 of the attachment panels 142, one or more stiffening features may be provided, such as ribs, flanges, or the like. As best seen in FIG. 4, attachment panel 142a includes an upper flange 148 extending continuously along an uppermost edge of the planar body 146. The upper flange 148 has a forward-facing rail flange portion 150, as well as a rear flange portion 151 along a rear portion of the planar body 146. An additional front flange 153 may extend along a forward edge of the planar body 146. As illustrated, the flange 148, rail flange portion 150, rear flange portion 151, and front flange 153 may each extend away from the planar body 146 in a direction normal/perpendicular to the planar body 146. Further, the flange 148, rail flange portion 150, and rear flange portion 151 may form a continuous flange along the uppermost and rearward-most edges of the planar body 146. The flanges 148, 150, 151, and 153 may collectively increase stiffness of the attachment panels 142. The planar body 146 and flanges 148, 150, 151, and 153 may be formed in any manner that is convenient, e.g., by being stamped from a sheet metal blank.

The rail 120 may be secured to apertures defined by the rail flange 150 at the corresponding end of the rail 120 with one or more threaded fasteners. Merely as an example, a pair of main bolts 152 may extend from a front side of the rail 120 through apertures defined by the rail 120 and by the rail flange 150, with the bolts 152 being secured with corresponding nuts 154, thereby clamping the rail 120 to the rail flange portion 150 of the attachment panel 142a. While not shown in FIG. 4, an opposite end of the rail 120 may be bolted to a rail flange of the attachment panel 142b in similar manner as described above regarding attachment panel 142a. Moreover, the attachment panel 142b may have attachment features such as attachment locations in the form of primary apertures 144 and secondary apertures 145, upper flange 148, rail flange 150, lower front flange 153, and lower rear flange 151 that are identical to those of the attachment panel 142a, but in mirror image with respect to those illustrated in the attachment panel 142a.

Although a variety of methods may be provided for moving the carriage 122 and robotic arm 106 along the rail 120, e.g., a slotted rail or automated drive, in an embodiment carriage includes hooks 160 that generally hang over the rail 120, thereby supporting the carriage 122. As best seen in FIGS. 4 and 5, a plurality of slide pads 162 are secured to the hooks 160 and are configured to engage a front surface 164, an upper surface 166, and a rear surface 168 of the rail 120. The slide pads 162 may be formed of any material that is convenient. In an example, the slide pads 162 are formed of Delrin or other suitable food-grade material that moves relatively easily along the surfaces 164, 166, 168 of the rail 120. The surfaces 164, 166, 168 may be formed of a metallic material that is relatively smooth to facilitate sliding of the carriage 122 along the rail 120. Other suitable materials for the carriage 122, slide pads 162, and/or the rail 120 may include Teflon or ultra-high molecular weight (UHMW) polyethylene, merely as examples.

A position of the carriage 122 and/or the robot arm 106 may be fixed at a lateral position along the rail 120 in any manner that is convenient. For example, as best seen in FIG. 5 a sensor-monitored attachment component may be provided that fixes a position of the carriage 122 to a defined location of the rail 120. In some examples, a retro reflective sensor, a laser displacement measurement, or encoder positioning may be employed to determine a location of the carriage 122 on the rail 120. In the illustrated example, the attachment component is an attachment pin 158, which may be actuated by a lever 172, thereby engaging the attachment pin 158 with a bottom surface of the rail 120, thereby preventing movement of the carriage 122 and robotic arm 106 along the rail 120. In some examples, the attachment pin 158 may be received within a corresponding slot, aperture, or the like in the rail 120, thereby providing a positive engagement at a predefined position along the rail 120 (e.g., corresponding to an operating location of the robotic arm 106). The attachment pin 158 may be disengaged from the rail 120 (or, in other example approaches, removed) to allow the carriage 122 to be moved along the rail 120, e.g., to permit use of different door(s) 134 of the fryers 104, as described above.

Although the present document has discussed a single robotic arm operational location along the rail 120, in some examples a robotic arm 106 may be operational at multiple lateral locations along the rail 120. So long as the robotic arm 106 is in a known lateral position (e.g., as determined by a sensor associated with a locking pin) on the rail 120, the movements of the robotic arm 106 may be modified based on that position. In this manner, maintenance and other operations may be performed by other automated equipment and/or by employees, while the robotic arm 106 continues to perform some or all operations.

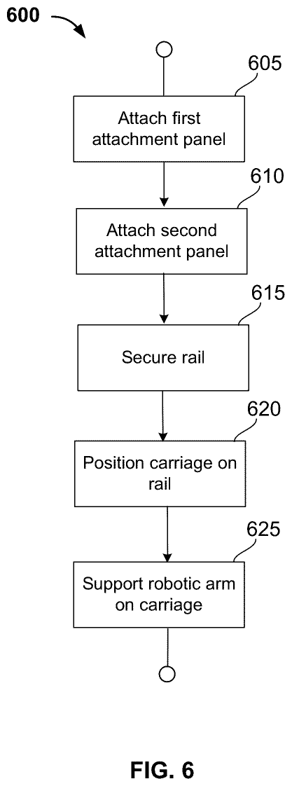

Referring now to FIG. 6, an example process 600 of securing a robotic arm to a cooking device in a robotic food preparation system is illustrated and described in further detail. Process 600 may begin at block 605, where a first attachment panel is rigidly attached to a cooking device at a plurality of attachment locations. For example, as described above, one of the attachment panels, e.g., attachment panel 142a, may be secured to fryer 104a with fasteners extending through apertures 144 in the panel 142a.

Proceeding to block 610, a second attachment panel may be rigidly physically attached to the cooking device at a second plurality of attachment locations. For example, as described above a second attachment panel 142b may be secured to fryer 104c with fasteners received in apertures 144. Process 600 may then proceed to block 615.

At block 615, first and second ends of a rail may be secured to their respective attachment panels 142. For example, an end of the rail 120 may be secured to a rail flange 150 of a first attachment panel, e.g., attachment panel 142a. The opposite end of the rail 120 may be secured to a rail flange of the opposite attachment panel 142b. Accordingly, the rail 120 may extend laterally across a front-facing surface of the cooking device 102. A lateral extent of the rail 120 may include an entire width of the cooking device 102, e.g., including the doors 132.

Proceeding to block 620, a carriage may be positioned on the rail that is configured to slide along the lateral extension of the rail. The carriage 122 may also include a locator to fix a position of the carriage along a lateral extension of the rail. For example, as noted above carriage 122 may be provided with hooks having slide pads configured to facilitate sliding of the carriage 122 along the rail 120. Process 600 may then proceed to block 625.

At block 625, the robotic arm may be supported with the carriage. For example, as noted above robotic arm 106 may be secured to the carriage 122 for movement with the carriage 122 along the rail 120. Additionally, when the carriage 122 is fixed at the first position, the robotic arm 106 may be positioned relative to the cooking device 102 to interact with the cooking device 102 to cook food items. For example, as discussed above the robotic arm 106 may be configured to move from a distinct position laterally along the rail 120.

The described robotic food preparation system provides a comprehensive solution for automating cooking processes, as may be of particular use for frying operations. Example systems and methods herein may integrate robotics, e.g., robotic arm 106, with mechanical and sensing components to ensure efficient, safe, and adaptable food preparation. By minimizing direct human interaction with hot cooking devices, the system enhances safety and productivity in kitchens.

The foregoing is merely illustrative of the principles of this disclosure and various modifications may be made by those skilled in the art without departing from the scope of this disclosure. The embodiments described herein are provided for purposes of illustration and not of limitation. Thus, this disclosure is not limited to the explicitly disclosed systems, devices, apparatuses, components, and methods, and instead includes variations to and modifications thereof, which are within the spirit of the attached claims.

The systems, devices, apparatuses, components, and methods described herein may be modified or varied to optimize the systems, devices, apparatuses, components, and methods. Moreover, it will be understood that the systems, devices, apparatuses, components, and methods may have many applications. The disclosed subject matter should not be limited to any single embodiment described herein, but rather should be construed according to the claims.

What is claimed is:

1. A robotic food preparation system for integration with a cooking device, comprising:
one or more attachment panels comprising a plurality of attachment locations for physically attaching to the cooking device;
a rail attached to the one or more attachment panels, wherein the rail is positioned to extend laterally across a front-facing surface of the cooking device when the one or more attachment panels are physically attached to the cooking device;
a carriage positioned on the rail to slidably engage along a lateral extension of the rail and including a locator to fix a first position of the carriage along a lateral extension of the rail; and
a robotic arm supported by the carriage, wherein, when the carriage is fixed at the first position, the robotic arm is positioned relative to the cooking device to interact with the cooking device to cook food items.

2. The robotic food preparation system of claim 1, wherein the rail is located above one or more doors of the cooking device such that the one or more doors are configured to open while the robotic arm is attached to the cooking device.

3. The robotic food preparation system of claim 2, wherein the carriage interferes with an opening of a first door of the one or more doors while the carriage is located at the first position, and wherein a sliding of the carriage along the rail allows the first door to be opened.

4. The robotic food preparation system of claim 1, further comprising a sensor configured to confirm that the locator has fixed the carriage at the first position, and wherein the robotic arm will not operate unless the sensor confirms that the carriage is fixed at the first position.

5. The robotic food preparation system of claim 1, further comprising a scanner located adjacent to a bottom side of the carriage, wherein the scanner identifies a presence of items in an area around the carriage.

6. The robotic food preparation system of claim 5, wherein, based on the identification of the presence of items, an operation of the robotic arm is modified, and wherein the modification of the operation of the robotic arm comprises the robotic arm modifying a range of motion, an order of operations, or a speed of movement.

7. The robotic food preparation system of claim 1, further comprising a plurality of utility connections coupled to the robotic arm, wherein the plurality of utility connections extend along the rail to a utility source.

8. The robotic food preparation system of claim 7, wherein the plurality of utility connections exit the rail at a first side of the rail, and wherein the plurality of utility connections have a length between a location of the coupling to the robot arm and the first side of the rail such that the carriage is configured to slide along the rail without tensioning any of the plurality of utility connections.

9. The robotic food preparation system of claim 1, wherein the cooking device comprises a plurality of fryers directly coupled to each other in a row, wherein the one or more attachment panels comprise a plurality of attachment panels, wherein a first attachment panel of the plurality of attachment panels attaches to a first side of a first fryer of the plurality of fryers, wherein a second attachment panel of the plurality of attachment panels attaches to a second side of a second fryer of the plurality of fryers, and wherein the rail extends laterally along the front-facing surface of each of the plurality of fryers.

10. The robotic food preparation system of claim 9, wherein the plurality of fryers comprise three fryers, wherein the first fryer is located on a left side of the row of fryers, the second fryer is located on a right side of the row of fryers, wherein a third fryer is located between the first fryer and the second fryer, wherein the first side is on the left side of the first fryer and the second side is on the right side of the second fryer.

11. The robotic food preparation system of claim 1, further comprising a dispenser and a basket reload station, wherein the dispenser dispenses food items to the basket reload station at a dispensing location, the basket reload station moves the food items to an access location, and the robotic arm access the food items via the access location.

12. The robotic food preparation system of claim 11, wherein the dispenser comprises a first dispenser, further comprising a second dispenser located adjacent to the first dispenser, and wherein both the first dispenser and the second dispenser dispense the food items to the dispensing location.

13. The robotic food preparation system of claim 1, wherein the attachment panel comprises a planar body configured to face a lateral side of the cooking device, the attachment panel comprising a plurality of flanges extending normal to the planar body.

14. The robotic food preparation system of claim 1, wherein the carriage comprises one or more hooks, each hook having a plurality of slide pads, the slide pads each configured to slide along a corresponding surface of the rail when the carriage is moved along the rail.

15. A support assembly configured to secure a robotic arm to a cooking device in a food preparation system, comprising:
a first attachment panel comprising a first plurality of attachment locations for physically attaching the first attachment panel to a first side of the cooking device;
a second attachment panel comprising a second plurality of attachment locations for physically attaching to a second side of the cooking device;
a rail having a first end and a second end, the first end attached to the first attachment panel, the second end attached to the second attachment panel such that the rail extends laterally across a front-facing surface of the one or more cooking devices when the one or more attachment panels are physically attached to the cooking device; and
a carriage positioned on the rail to slidably engage along a lateral extension of the rail and including a locator to fix a first position of the carriage along the lateral extension of the rail.

16. The support assembly of claim 15, further comprising the robotic arm, wherein, when the carriage is fixed at the first position, the robotic arm is positioned relative to the cooking device to interact with the cooking device to cook food items.

17. The support assembly of claim 15, wherein the one or more cooking devices a plurality of fryers; wherein the rail is located above one or more doors of the cooking device such that the one or more doors are capable of opening while the robotic arm is attached to the cooking device; and wherein the carriage interferes with an opening of a first door of the one or more doors while the carriage is located at the first position, and wherein a sliding of the carriage along rail allows the first door to be opened.

18. The support assembly of claim 15, wherein the first attachment panel comprises a first planar body configured to face a first lateral side of the cooking device, and wherein the second attachment panel comprises a second planar body configured to face a second lateral side of the cooking device, wherein the first attachment panel and the second attachment panel each comprise a flange extending normal to its respective planar body.

19. The support assembly of claim 15, wherein the carriage comprises one or more hooks, each hook having a plurality of slide pads, the slide pads each configured to slide along a corresponding surface of the rail when the carriage is moved along the rail.

20. A method of securing a robotic arm to a cooking device in a robotic food preparation system, the method comprising:
physically attaching a first attachment panel to the cooking device at a plurality of attachment locations;
physically attaching a second attachment panel to the cooking device at a second plurality of attachment locations;
attaching a first end of a rail to the first attachment panel, and attaching a second end of the rail to the second attachment panel, wherein the rail extends laterally across a front-facing surface of the cooking device;
positioning a carriage on the rail, the carriage configured to slide along a lateral extension of the rail, the carriage including a locator to fix a first position of the carriage along a lateral extension of the rail; and
supporting the robotic arm with the carriage, wherein, when the carriage is fixed at the first position, the robotic arm is positioned relative to the cooking device to interact with the cooking device to cook food items.
